(19) United States
(12) Patent Application Publication
(10) Pub. No.: US 2025/0184848 A1
(43) Pub. Date: Jun. 5, 2025

(54) METHOD AND APPARATUS FOR A CONNECTION HANDLING MECHANISM IN A L2 U2N RELAY CASE

(71) Applicant: LENOVO (BEIJING) LIMITED, Beijing (CN)

(72) Inventors: Lianhai Wu, Beijing (CN); Haiming Wang, Beijing (CN); Ran Yue, Beijing (CN)

(21) Appl. No.: 18/844,126

(22) PCT Filed: Jul. 27, 2022
(86) PCT No.: PCT/CN2022/108372

§ 371 Date: Sep. 5, 2024

(51) Int. Cl. H04W 36/18; H04W 76/19; H04W 76/20; H04W 76/30; H04W 92/18

(52) U.S. Cl. CPC H04W 36/18; H04W 76/19; H04W 76/20; H04W 76/30; H04W 92/18

(57) ABSTRACT

Embodiments of the present disclosure relate to methods and apparatuses for a connection handling mechanism in a Layer-2 (L2) UE-to-network (U2N) relay case in a communication system. According to an embodiment of the present application, a user equipment (UE) includes a transceiver and a processor coupled to the transceiver; and the processor is configured to: access a network node over an indirect path associated with a source relay node; in response to reception of a radio resource control (RRC) reconfiguration message for path switch via the transceiver from the network node, perform a path switch procedure from the indirect path to a target path, wherein the target path is a direct path between the UE and the network node or is another indirect path between the UE and the network node associated with a target relay node; and receive data via the transceiver from the source relay node over a source link between the UE and the source relay node during the path switch procedure.

### TECHNICAL FIELD

Embodiments of the present disclosure generally relate to communication technology, and more particularly to a connection handling mechanism in a Layer-2 (L2) UE-to-network (U2N) relay case in a communication system.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3rd Generation Partnership Project (3GPP) Release 12, and enables a direct communication between proximal UEs, and data does not need to go through a base station (BS) or a core network.

In the 3GPP, deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

Currently, in a wireless communication system or the like, details regarding a connection handling mechanism in a L2 U2N relay case have not been specifically discussed yet.

### SUMMARY

Some embodiments of the present disclosure provide a user equipment (UE). The UE may include: a transceiver; and a processor coupled to the transceiver. The processor may be configured to: access a network node over a first indirect path associated with a source relay node; in response to reception of a radio resource control (RRC) reconfiguration message for path switch via the transceiver from the network node, perform a path switch procedure from the first indirect path to a target path, wherein the target path is a direct path between the UE and the network node or is a second indirect path between the UE and the network node associated with a target relay node; and receive data via the transceiver from the source relay node over a source link between the UE and the source relay node during the path switch procedure.

In some embodiments of the present disclosure, the processor of the UE is configured to, in response to the reception of the RRC reconfiguration message for path switch, stop reception of at least one of user plane (UP) data or control plane (CP) data via the transceiver from the source relay node.

In some embodiments of the present disclosure, the processor of the UE is configured to: receive a first notification message or a PC5 unicast link release indication from the source relay node during the path switch procedure; in response to reception of the first notification message or the PC5 unicast link release indication and in response to a timer for path switch being running, perform at least one of: ignoring the first notification message or the PC5 unicast link release indication; stopping reception of at least one of UP data or CP data from the source relay node; or releasing the source link between the UE and the source relay node.

In some embodiments of the present disclosure, the first notification message is received via the transceiver from the source relay node, and wherein the PC5 unicast link release indication is indicated by an upper layer of the UE or is received via the transceiver from the source relay node.

In some embodiments of the present disclosure, in response to the path switch procedure being a dual active protocol stack (DAPS) path switch procedure, the processor of the UE is configured to perform at least one of: receiving a second notification message via the transceiver from the target relay node; receiving a PC5 unicast link release indication, wherein the PC5 unicast link release indication is indicated by an upper layer of the UE or is received via the transceiver from the target relay node; or detecting a radio link failure (RLF) on a link between the UE and the target relay node.

In some embodiments of the present disclosure, the processor of the UE is configured to perform at least one of: reverting to the source link in response to the source link being available; or transmitting failure related information via the transceiver to the network node.

In some embodiments of the present disclosure, the processor of the UE is configured to: perform a reestablishment procedure in response to the source link being not available; after completing the reestablishment procedure, receive a request via the transceiver from the network node; and transmit a response including failure related information via the transceiver to the network node.

In some embodiments of the present disclosure, the failure related information indicates at least one of: reception of the second notification message from the target relay node; reception of the PC5 unicast link release indication; or detection of the RLF on the link between the UE and the target relay node.

In some embodiments of the present disclosure, the processor of the UE is configured to: receive a PC5 unicast link release indication before the reception of the RRC reconfiguration message for path switch; and in response to a timer for RRC reestablishment request being not running and in response to the UE in an RRC connected state, perform a reestablishment procedure.

In some embodiments of the present disclosure, the processor of the UE is configured to: receive a PC5 unicast link release indication before the reception of the RRC reconfiguration message for path switch; and in response to a timer for RRC reestablishment request being running, perform at least one of: entering an RRC idle state; or stopping the timer for RRC reestablishment request.

In some embodiments of the present disclosure, in response to the timer for RRC reestablishment request being running, the processor of the UE is further configured to perform actions upon entering the RRC idle state.

In some embodiments of the present disclosure, the PC5 unicast link release indication is indicated by an upper layer of the UE or is received via the transceiver from the source relay node.

In some embodiments of the present disclosure, the processor of the UE is configured to: receive a third notification message via the transceiver from the source relay node before the reception of the RRC reconfiguration message for path switch; and perform a reestablishment procedure, in response to: a timer for RRC reestablishment request being not running and the UE in an RRC connected state; or the UE being not performing the reestablishment procedure and the UE in the RRC connected state.

In some embodiments of the present disclosure, at least one of the first notification message, the second notification message, or the third notification message is triggered by at least one of: an occurrence of a Uu RLF; reception of an RRC reconfiguration message including a configuration with synchronization; a cell reselection; an occurrence of an RRC connection failure; an RRC connection rejection; an expiry of a timer for RRC setup request; and an occurrence of an RRC resume failure.

Some embodiments of the present disclosure provide a relay node. The relay node may include: a transceiver; and a processor coupled to the transceiver. The processor may be configured to transmit at least one of a notification message or a PC5 unicast link release indication via the transceiver to a user equipment (UE) during the UE performing a path switch procedure from a source path to a target path, wherein the source path is a first direct path between the UE and the network node or is a first indirect path between the UE and the network node associated with a source relay node; wherein the target path is a second direct path between the UE and the network node or is a second indirect path between the UE and the network node associated with a target relay node; and wherein the relay node functions as the source relay node or the target relay node.

In some embodiments of the present disclosure, in response to the relay node functioning as the source relay node, the processor of the relay node is configured to: receive a measurement result from the UE and transmit the measurement result to the network node via the transceiver over the first indirect path between the UE and the network node; and transmit data via the transceiver to the UE over a source link between the UE and the source relay node during the UE performing the path switch procedure.

In some embodiments of the present disclosure, in response to the relay node functioning as the target relay node, the path switch procedure is a dual active protocol stack (DAPS) path switch procedure.

In some embodiments of the present disclosure, the notification message is triggered by at least one of: an occurrence of a Uu RLF at the relay node; reception of an RRC reconfiguration message including a configuration with synchronization at the relay node; a cell reselection of the relay node; an occurrence of an RRC connection failure at the relay node; an RRC connection rejection to the relay node; an expiry of a timer for RRC setup request at the relay node; and an occurrence of an RRC resume failure at the relay node.

Some embodiments of the present disclosure provide a network node (e.g., a BS). The network node may include: a transceiver; and a processor coupled to the transceiver. The processor may be configured to: transmit a request via the transceiver to a user equipment (UE) after the UE completing a reestablishment procedure to the network node, wherein the reestablishment procedure is initiated by the UE in response to an occurrence of a failure during the UE performing a path switch procedure from a source path to a target path and in response to a source link between the UE and a source relay node being not available, wherein the source path is a first direct path between the UE and the network node or is a first indirect path between the UE and the network node associated with a source relay node, and wherein the target path is a second direct path between the UE and the network node or is a second indirect path between the UE and the network node associated with a target relay node; and receive a response including failure related information via the transceiver from the UE.

In some embodiments of the present disclosure, the failure related information indicates at least one of: reception of a notification message by the UE from the target relay node; reception of a PC5 unicast link release indication, wherein the PC5 unicast link release indication is indicated by an upper layer of the UE or is received by the UE from the target relay node; or detection of a radio link failure (RLF) on the link between the UE and the target relay node.

In some embodiments of the present disclosure, the path switch procedure is a dual active protocol stack (DAPS) path switch procedure.

Some embodiments of the present disclosure provide a method performed by a user equipment (UE). The method may include: accessing a network node over a first indirect path associated with a source relay node; in response to reception of a radio resource control (RRC) reconfiguration message for path switch from the network node, performing a path switch procedure from the first indirect path to a target path, wherein the target path is a direct path between the UE and the network node or is a second indirect path between the UE and the network node associated with a target relay node; and receiving data from the source relay node over a source link between the UE and the source relay node during the path switch procedure.

Some embodiments of the present disclosure provide a method performed by a relay node. The method may include: transmitting at least one of a notification message or a PC5 unicast link release indication to a user equipment (UE) during the UE performing a path switch procedure from a source path to a target path, wherein the source path is a first direct path between the UE and the network node or is a first indirect path between the UE and the network node associated with a source relay node; wherein the target path is a second direct path between the UE and the network node or is a second indirect path between the UE and the network node associated with a target relay node; and wherein the relay node functions as the source relay node or the target relay node.

Some embodiments of the present disclosure provide a method performed by a network node. The method may include: transmitting a request to a user equipment (UE) after the UE completing a reestablishment procedure to the network node, wherein the reestablishment procedure is initiated by the UE in response to an occurrence of a failure during the UE performing a path switch procedure from a source path to a target path and in response to a source link between the UE and a source relay node being not available, wherein the source path is a first direct path between the UE and the network node or is a first indirect path between the UE and the network node associated with a source relay node, and wherein the target path is a second direct path between the UE and the network node or is a second indirect path between the UE and the network node associated with a target relay node; and receiving a response including failure related information from the UE.

Some embodiments of the present disclosure provide a user equipment (UE). The UE may include: a transceiver; and a processor coupled to the transceiver. The processor may be configured to: access a network node over an indirect path via a relay node; and receive data via the transceiver from the relay node over a link between the UE and the relay node; receive at least one of a notification message or a PC5 unicast link release indication.

In some embodiments of the present disclosure, the notification message is received via the transceiver from the relay node, and wherein the PC5 unicast link release indication is indicated by an upper layer of the UE or is received via the transceiver from the relay node.

In some embodiments of the present disclosure, in response to reception of the PC5 unicast link release indication, in response to a timer for RRC reestablishment request being not running, and in response to the UE in an RRC connected state, the processor of the UE is configured to perform a reestablishment procedure.

In some embodiments of the present disclosure, in response to reception of the PC5 unicast link release indication, in response to a timer for RRC reestablishment request being running, the processor of the UE is configured to perform at least one of: entering an RRC idle state; or stopping the timer for RRC reestablishment request.

In some embodiments of the present disclosure, the processor of the UE is further configured to perform actions upon entering the RRC idle state.

In some embodiments of the present disclosure, in response to reception of the notification message, the processor of the UE is configured to perform a reestablishment procedure, in response to: a timer for RRC reestablishment request being not running and the UE in an RRC connected state; or the UE being not performing the reestablishment procedure and the UE in the RRC connected state.

In some embodiments of the present disclosure, the notification message is associated with one or more conditions at the relay UE, and wherein the one or more conditions include at least one of: an occurrence of a Uu RLF; reception of an RRC reconfiguration message including a configuration with synchronization; a cell reselection; an occurrence of an RRC connection failure; an RRC connection rejection; an expiry of a timer for RRC setup request; and an occurrence of an RRC resume failure.

Some embodiments of the present disclosure provide a method performed by a user equipment (UE). The method may include: accessing a network node over an indirect path via a relay node; and receiving data via the transceiver from the relay node over a link between the UE and the relay node; receiving at least one of a notification message or a PC5 unicast link release indication.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2 illustrates a schematic diagram of a relay based wireless communication system in accordance with some embodiments of the present disclosure.

FIG. 3 illustrates an exemplary procedure for a notification message in accordance with some embodiments of the present disclosure.

FIG. 4 illustrates an exemplary UE information procedure in accordance with some embodiments of the present disclosure.

FIGS. 5 and 6 illustrate flowcharts of exemplary procedures of wireless communications in accordance with some embodiments of the present disclosure.

FIGS. 7-11 illustrate schematic diagrams of a wireless communication system in accordance with some embodiments of the present disclosure.

FIG. 12 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

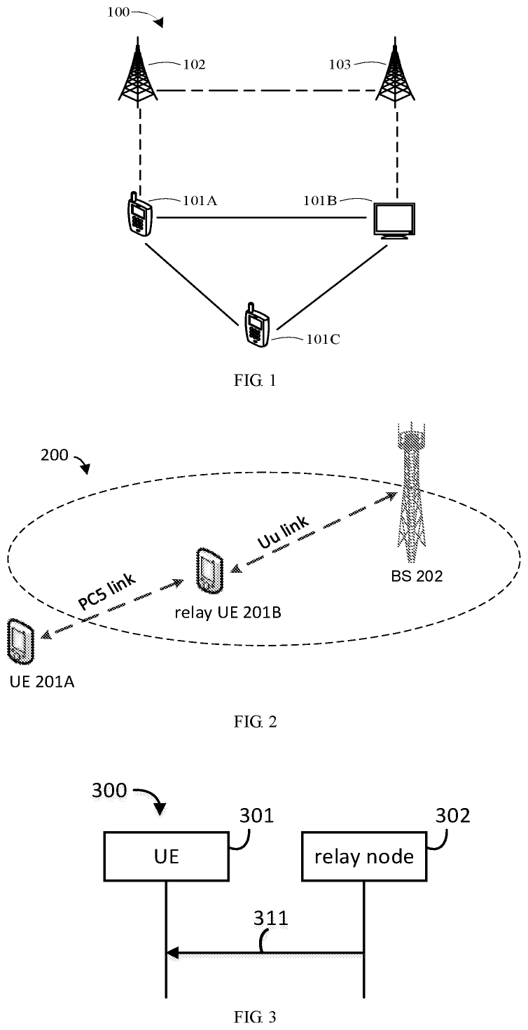

FIG. 1 illustrates a schematic diagram of wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP TS 38 series specification) may refer to access stratum (AS) functionality enabling at least vehicle-to-everything (V2X) communications between neighboring UEs, using NR technology but not traversing any network node. V2X sidelink communications (e.g., specified in 3GPP TS 36 series specification) may refer to AS functionality enabling V2X communications between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, wireless communication system 100 may include some base stations (e.g., BS 102 and BS 103) and some UEs (e.g., UE 101A, UE 101B, and UE 101C). Although a specific number of UEs and BSs are depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, BS 102 and BS 103 may be included in a next generation radio access network (NG-RAN). In some embodiments of the present disclosure, BS 102 may be a gNB and BS 103 may be an ng-eNB.

UE 101A and UE 101B may be in-coverage (e.g., inside the NG-RAN). For example, as shown in FIG. 1, UE 101A may be within the coverage of BS 102, and UE 101B may be within the coverage of BS 103. UE 101C may be out-of-coverage (e.g., outside the coverage of the NG-RAN). For example, as shown in FIG. 1, UE 101C may be outside the coverage of any BS, for example, both BS 102 and BS 103. UE 101A and UE 101B may respectively connect to BS 102 and BS 103 via a network interface, for example, the Uu interface as specified in 3GPP specification. The control plane protocol stack in the Uu interface may include an RRC layer, which may be referred to as a Uu RRC. The link established between a UE (e.g., UE 101A) and a BS (e.g., BS 102) may be referred to as a Uu link. BS 102 and BS 103 may be connected to each other via a network interface, for example, the Xn interface as specified in 3GPP standard documents. UE 101A, UE 101B, and UE 101C may be connected to each other respectively via, for example, a PC5 interface as specified in 3GPP standard documents. The control plane protocol stack in the PC5 interface may include an RRC layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, UE 101A, which is within the coverage of BS 102, can perform sidelink transmission and reception (e.g., sidelink unicast transmission, sidelink groupcast transmission, or sidelink broadcast transmission) over a PC5 interface. UE 101C, which is outside the coverage of both BS 102 and BS 103, can also perform sidelink transmission(s) and reception(s) over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. A Sidelink relay can provide connectivity to the network for another UE (remote UE). In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote ULE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be respectively referred to as the serving BS or serving cell of the remote UE.

A remote UE may have RRC states, such as an RRC_IDLE state, an RRC_INACTIVE state, and an RRC_CONNECTED state as defined in 3GPP specifications. An RRC_IDLE state may also be named as an RRC idle state or the like. An RRC_INACTIVE state may also be named as an RRC inactive state or the like. An RRC_CONNECTED state may also be named as an RRC connected state or the like. A relay UE may be in an RRC_CONNECTED state to perform relaying of unicast data. In some embodiments, in a path switch case, a relay UE in an RRC_IDLE, RRC_INACTIVE or RRC_CONNECTED state can be selected as a target relay UE.

In some embodiments, the following RRC state combinations may be supported for a L2 U2N Relay operation:
Both the relay UE and the remote UE may be in an RRC_CONNECTED state to perform transmission or reception of relayed unicast data; and
The relay UE can be in an RRC_IDLE, RRC_INACTIVE or RRC_CONNECTED state as long as every remote UE that is connected to the relay UE is either in an RRC_INACTIVE state or in an RRC_IDLE state.

A single unicast link may be established between one relay UE and one remote UE. The traffic of the remote UE via a given relay UE and the traffic of the relay UE may be separated in different Uu relay radio link control (RLC) channels. In some embodiments, for the L2 U2N relay, the remote UE may only be configured to use resource allocation mode 2 for data to be relayed.

FIG. 2 illustrates a schematic diagram of relay-based wireless communication system 200 in accordance with some embodiments of the present disclosure. Details described in all of the foregoing embodiments of the present disclosure are applicable for the embodiments shown in FIG. 2.

As shown in FIG. 2, wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1. UE 201B may also be named as relay UE 201B as shown in FIG. 2.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may also be referred to as a remote UE and UE 201B may also be referred to as a relay UE, a sidelink relay, or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

FIG. 3 illustrates a flowchart of exemplary procedure 300 for a notification message in accordance with some embodiments of the present disclosure. Details described in all of the foregoing embodiments of the present disclosure are applicable for the embodiments shown in FIG. 3.

Referring to FIG. 3, in some embodiments, in operation 311, relay node 302 may transmit a notification message to UE 301. In some examples, relay node 302 may be a relay UE such as a U2N relay UE. In this scenario, the notification message may also be referred to as “a notification message for sidelink” or “NotificationMessageSidelink message” or the like.

In some embodiments of the present disclosure, relay node 302 may initiate exemplary procedure 300 when, for example, one of the following conditions is met:
in response to a Uu RLF as will be described below; or
in response to the reception of an RRC reconfiguration message including a reconfigurationWithSync information element (IE), such as a handover command; or
in response to cell reselection at relay node 302; or
in response to an RRC connection failure at relay node 302, which may include, for example, an RRC connection rejection, an expiry of a timer for RRC setup request (e.g., T300 as specified in 3GPP specifications), and an RRC resume failure.

The notification message may include a type indication (e.g., “indicationType”), which may indicate that the notification message is due to one of a relay Uu RLF, relay handover, relay cell reselection, and/or relay connection failure.

In some embodiments of the present disclosure, a relay node (e.g., relay node 302) may declare a Uu RLF (e.g., an RLF between the relay node and the BS) based on at least one of the following criteria:
the expiry of a radio problem timer started after the indication of radio problems from the physical layer (if the radio problems are recovered before the timer is expired, the relay node stops the timer); or
the expiry of a timer started upon triggering a measurement report for a measurement identity for which the timer has been configured while another radio problem timer is running; or
a random access procedure failure; or
an RLC failure.

In some other embodiments of the present disclosure, either L2 U2N Relay UE or L2 U2N Remote UE's access stratum (AS) layer can release PC5-RRC connection and indicates upper layer of a UE to release PC5 unicast link, e.g., after receiving RRCReconfiguration message from a BS. The timing to execute a PC5 unicast link release is up to the UE's implementation(s).

For example, referring back to FIG. 3, in operation 311, relay node 302 may transmit a PC5 unicast link release indication to UE 301. In some examples, relay node 302 may be a relay UE such as a U2N relay UE. In this scenario, the PC5 unicast link release indication may also be named as a PC5 unicast link release message or the like. The PC5 unicast link release indication may be transmitted in PC5-S messages from the upper layers of UE 301 to AS layer of UE 301.

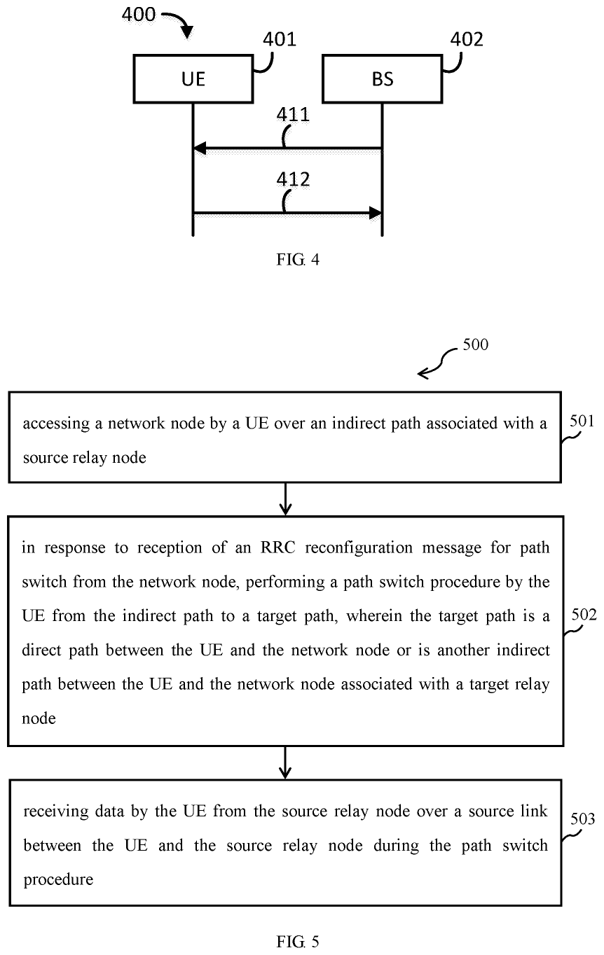

FIG. 4 illustrates an exemplary UE information procedure in accordance with some embodiments of the present disclosure. Details described in all of the foregoing embodiments of the present disclosure are applicable for the embodiments shown in FIG. 4. The embodiments of FIG. 4 show a procedure of a UE (e.g., UE 401) communicating with a BS (e.g., BS 402). In some examples, UE 401 may function as UE 201A in FIG. 2. BS 402 may function as BS 202 in FIG. 2.

As shown in FIG. 4, in operation 411, BS 402 transmits UE Information Request message to UE 401. BS 402 may be a source BS which controls a serving cell of UE 401. In operation 412, US 401 transmits UE Information Response message (e.g., including a RLF report) to BS 402. BS 402 can optimize a mobility problem based on the response transmitted from UE 401.

In some embodiments of the present disclosure, a remote UE may be switched (or handed over) from an indirect path (e.g., the UE indirectly accesses a source BS (or source cell) via a source relay node) to another indirect path (e.g., the UE indirectly accesses a target BS (or target cell) via a target relay node). In some embodiments of the present disclosure, a remote UE may be switched (or handed over) from a direct path (e.g., the UE directly accesses a target BS (or target cell) without any relay node) to an indirect path (e.g., the UE indirectly accesses a target BS (or target cell) via a target relay node).

For example, in a procedure for switching from indirect path to direct Uu cell, if a L2 U2N Remote UE communicates with a network node (e.g., a BS) over an indirect path via a L2 U2N relay UE, once the BS decides to switch the L2 U2N Remote UE onto a direct Uu path, the BS may send RRCReconfiguration message to the L2 U2N Remote UE. Then, the L2 U2N Remote UE may synchronize with the BS and performs a random access (RA) procedure. The L2 U2N Remote UE may send the RRCReconfigurationComplete message to the BS via a direct Uu path, e.g., using the configuration provided in an RRCReconfiguration message. After this step, the L2 U2N Remote UE may use the RRC connection via the direct Uu path to the BS.

In general, a DAPS path switch (or DAPS handover) is introduced wherein a UE maintains a source cell (or source BS) connection after reception of a handover command associated with DAPS, and only releases the source cell connection after a successful access to the target cell (or target BS). This may also be referred to as “soft handover”. In the case of a DAPS handover, a UE may continue to receive data (e.g., UP data and/or CP data) from the source until releasing the source cell and continue to transmit the UL user data transmission to the source BS until a successful random access procedure to the target BS. In the context of the present disclosure, “handover” and “path switch” may be used interchangeably.

Currently, details regarding a connection handling mechanism in different scenarios in a L2 U2N relay case have not been specifically discussed yet in a wireless communication system or the like. For example, some embodiments of the present disclosure provide mechanisms for a case that a remote UE receives a notification message or a PC5 unicast link release indication from a source relay UE when the remote UE is performing a path switch procedure. Some embodiments of the present disclosure introduce mechanisms for transmitting failure related information associated with reception of a notification message or a PC5 unicast link release indication or an RLF on a PC5 link for a DAPS path switch procedure. Some embodiments of the present disclosure study a condition to trigger a reestablishment procedure and transit to an RRC_IDLE state when a remote UE receives a PC5 unicast link release indication.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 5 illustrates a flowchart of an exemplary procedure 500 of performing a path switch procedure in accordance with some embodiments of the present disclosure. Details described in all of other embodiments of the present disclosure are applicable for the embodiments shown in FIG. 5. The exemplary procedure 500 may be performed by a UE, for example, UE 110c in FIG. 1 or UE 201A in FIG. 2.

In the exemplary procedure 500, in operation 501, a UE (e.g., UE 201A in FIG. 2) may access a network node (e.g., BS 202 in FIG. 2) over an indirect path associated with a source relay node (e.g., relay UE 201B in FIG. 2).

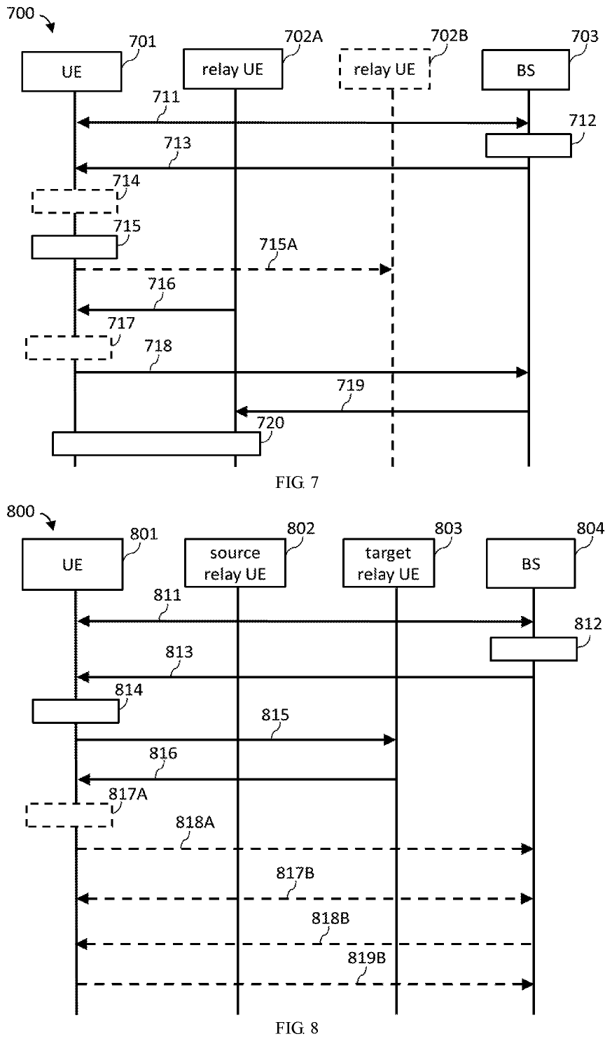

In operation 502, in response to reception of an RRC reconfiguration message for path switch from the network node, the UE may perform a path switch procedure from the indirect path to a target path. The target path may be “a direct path between the UE and the network node” or “another indirect path between the UE and the network node associated with a target relay node”. In some embodiments, in response to the reception of the RRC reconfiguration message for path switch, the UE may stop reception of at least one of user plane (UP) data or control plane (CP) data from the source relay node. A specific example is described in operation 714 in the embodiments of FIG. 7 as below.

In operation 503, the UE may receive data (e.g., UP data and/or CP data) from the source relay node over “a source link between the UE and the source relay node” during the path switch procedure.

In some embodiments, the UE may receive a notification message (denoted as notification message #1 for simplicity) or a PC5 unicast link release indication from the source relay node during the path switch procedure. In response to reception of notification message #1 or the PC5 unicast link release indication and in response to a timer for path switch being running (e.g., T304 as specified in 3GPP specifications), the UE may perform at least one of:
(1) ignoring notification message #1;
(2) ignoring the PC5 unicast link release indication;
(3) stopping reception of at least one of UP data or CP data from the source relay node; or
(4) releasing the source link between the UE and the source relay node. A specific example is described in Option 1, Option 2, or Option 3 of operation 717 in the embodiments of FIG. 7 as below.

In some embodiments, notification message #1 is received by the UE from the source relay node. In some embodiments, the PC5 unicast link release indication is indicated by an upper layer of the UE or is received by the UE from the source relay node.

In some embodiments, in response to that the path switch procedure is a DAPS path switch procedure, the UE may perform at least one of:
(1) receiving a further notification message (denoted as notification message #2 for simplicity) from the target relay node (e.g., target relay UE 803);
(2) receiving a PC5 unicast link release indication, which may be indicated by an upper layer of the UE or is received from the target relay node; or
(3) detecting an RLF on a link between the UE and the target relay node. Specific examples are described in operations 817A and 817B in the embodiments of FIG. 8 as below.

In some embodiments, the UE may perform at least one of: reverting to the source link in response to the source link being available; or transmitting failure related information to the network node, e.g., in operation 817A in the embodiments of FIG. 8.

In some other embodiments, the UE may perform a reestablishment procedure in response to the source link being not available, e.g., in operation 817B in the embodiments of FIG. 8. After completing the reestablishment procedure, the UE may receive a request from the network node, and transmit a response including failure related information to the network node. In an embodiment, the failure related information indicates at least one of:
(1) reception of notification message #2 from the target relay node;
(2) reception of the PC5 unicast link release indication; or
(3) detection of the RLF on the link between the UE and the target relay node.

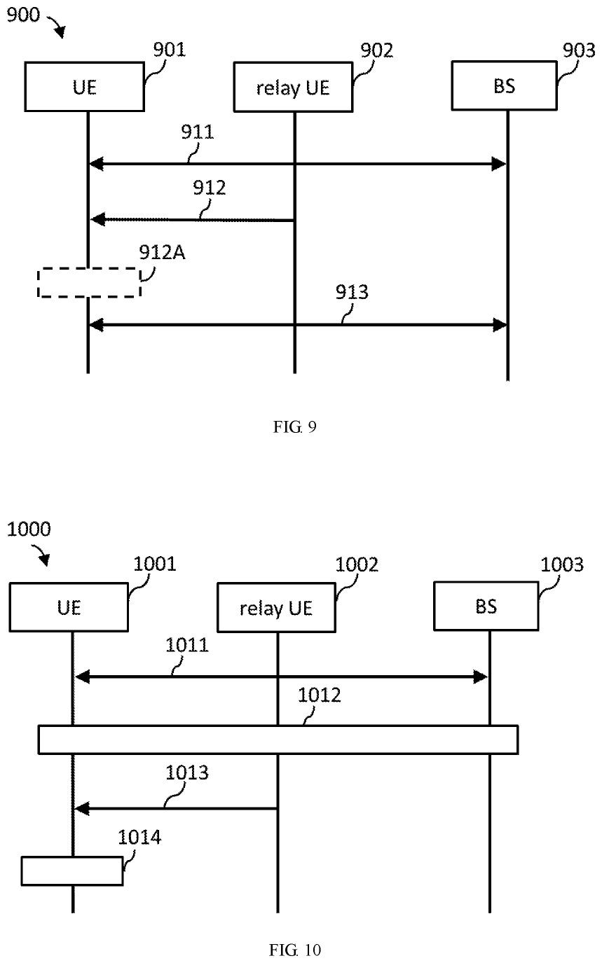

In some embodiments, the UE may receive a PC5 unicast link release indication before the reception of the RRC reconfiguration message for path switch; and in response to a timer for RRC reestablishment request (e.g., T301 as specified in 3GPP specifications) being not running and in response to the UE in an RRC connected state, perform a reestablishment procedure. A specific example is described in the embodiments of FIG. 9 as below.

In some embodiments, the UE may receive a PC5 unicast link release indication before the reception of the RRC reconfiguration message for path switch. In response to a timer for RRC reestablishment request (e.g., T301) being running, the UE may perform at least one of: entering an RRC idle state; or stopping the timer for RRC reestablishment request. A specific example is described in the embodiments of FIG. 10 as below. In an embodiment, in response to the timer for RRC reestablishment request (e.g., T301) being running, the UE may perform actions upon entering the RRC idle state. For instance, upon going to the RRC idle state, the UE may reset MAC; stop all timers that are running except timers T302, T320, T325, T330, T331 and T400; discard the UE Inactive AS context, if any; release the suspendConfig, if configured; remove all the entries within VarConditionalReconfig, if any; discard the K_{gNB} key, the S-K_{gNB} key, the S-K_{eNB} key, the K_{RRCenc} key, the K_{RRCint} key, the K_{UPint} key and the K_{UPenc} key, if any; release all radio resources, including release of the RLC entity, the BAP entity, the MAC configuration and the associated PDCP entity and SDAP for all established RBs; indicate the release of the RRC connection to upper layers together with the release cause; discard any segments of segmented RRC messages stored; and/or enter the RRC idle state and perform a cell selection.

In some embodiments, the PC5 unicast link release indication is indicated by an upper layer of the UE or is received from the source relay node.

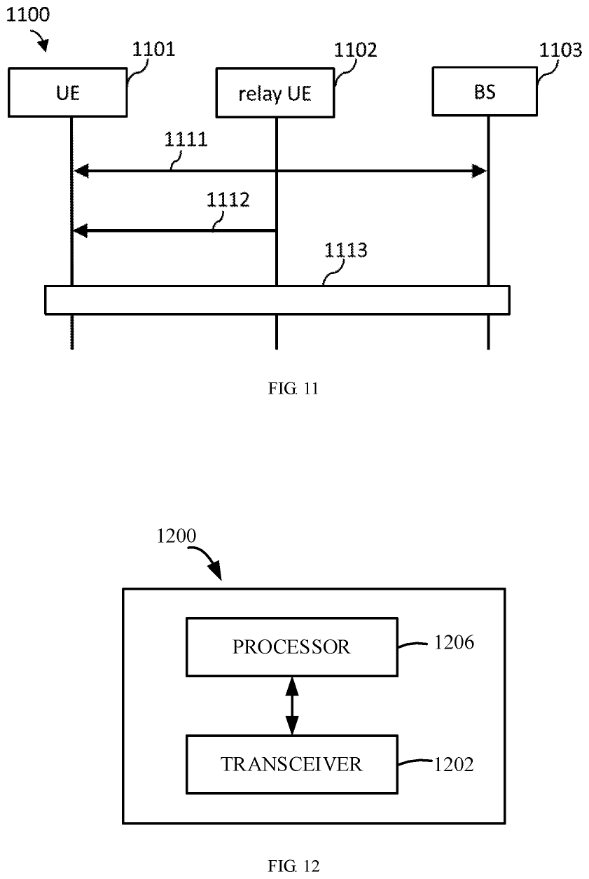

In some embodiments of the present disclosure, the UE may receive another notification message (denoted as notification message #3 for simplicity) from the source relay node before the reception of the RRC reconfiguration message for path switch; and perform a reestablishment procedure, in response to: a timer for RRC reestablishment request (e.g., T301) being not running and the UE in an RRC connected state; or the UE being not performing the reestablishment procedure and the UE in the RRC connected state. A specific example is described in the embodiments of FIG. 11 as below.

In some embodiments of the present disclosure, at least one of notification message #1, notification message #2, or notification message #3 is triggered by at least one of:
(1) an occurrence of a Uu RLF;
(2) reception of an RRC reconfiguration message including a configuration with synchronization;
(3) a cell reselection;
(4) an occurrence of an RRC connection failure;
(5) an RRC connection rejection;
(6) an expiry of a timer for RRC setup request (e.g., T300); and
(7) an occurrence of an RRC resume failure.

It should be appreciated by persons skilled in the art that the sequence of the operations in exemplary procedure 500 may be changed and some of the operations in exemplary procedure 500 may be eliminated or modified, without departing from the spirit and scope of the disclosure.

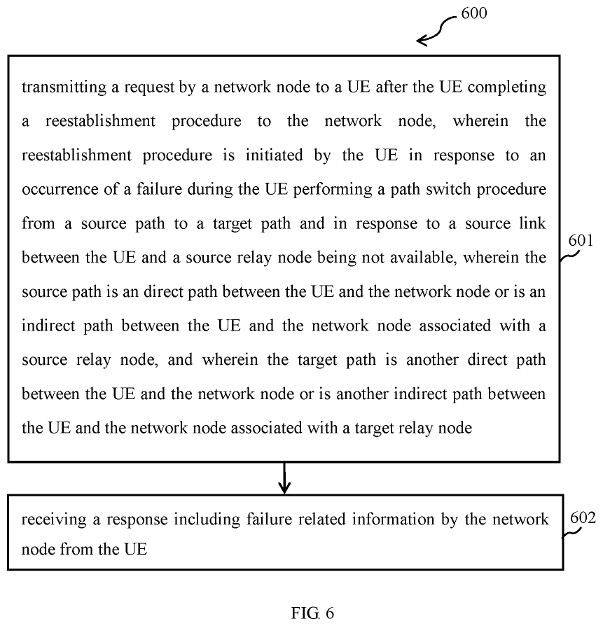

FIG. 6 illustrates a flowchart of an exemplary procedure 200 of initializing a COT in accordance with some embodiments of the present disclosure. Details described in all of other embodiments of the present disclosure are applicable for the embodiments shown in FIG. 6. In some examples, the procedure may be performed by a network node (e.g., a BS), for example, BS 202 in FIG. 2.

In the exemplary procedure 600, in operation 601, a network node may transmit a request to a UE after the UE completing a reestablishment procedure to the network node. The reestablishment procedure may be initiated by the UE in response to an occurrence of a failure during the UE performing a path switch procedure from a source path to a target path and in response to a source link between the UE and a source relay node being not available. The source path may be “a direct path between the UE and the network node” or “an indirect path between the UE and the network node associated with a source relay node”. The target path may be “another direct path between the UE and the network node” or “another indirect path between the UE and the network node associated with a target relay node”.

In operation 602, the UE may receive a response including failure related information by the network node from the UE. In an embodiment, the failure related information indicates at least one of:
(1) reception of a notification message by the UE from the target relay node;
(2) reception of a PC5 unicast link release indication, which may be indicated by an upper layer of the UE or is received by the UE from the target relay node; or
(3) detection of an RLF on the link between the UE and the target relay node.

In some embodiments of the present disclosure, the path switch procedure is a DAPS path switch procedure. A specific example is described in the embodiments of FIG. 8 as below.

It should be appreciated by persons skilled in the art that the sequence of the operations in exemplary procedure 600 may be changed and some of the operations in exemplary procedure 600 may be eliminated or modified, without departing from the spirit and scope of the disclosure.

In addition, some embodiments of the present disclosure provide an exemplary procedure performed by a relay node (e.g., a relay UE), for example, UE 110b in FIG. 1. Although described with respect to a relay node, it should be understood that other devices may be configured to perform a similar procedure.

It should be appreciated by persons skilled in the art that the sequence of the operations in this exemplary procedure of a relay node may be changed and some of the operations in this exemplary procedure may be eliminated or modified, without departing from the spirit and scope of the disclosure. Details described in all other embodiments of the present application, e.g., in the embodiments of FIGS. 5-12 are applicable for this exemplary procedure. Moreover, details described in this exemplary procedure are applicable for all the embodiments of FIGS. 1-12.

In particular, in this exemplary procedure, a relay node may transmit at least one of a notification message or a PC5 unicast link release indication to a UE (e.g., UE 201A in FIG. 2) during the UE performing a path switch procedure from a source path to a target path. The source path may be “a direct path between the UE and the network node” or “an indirect path between the UE and the network node associated with a source relay node”. The target path may be “another direct path between the UE and the network node” or “another indirect path between the UE and the network node associated with a target relay node”. The relay node functions as the source relay node or the target relay node in different embodiments.

In some embodiments, the notification message is triggered by at least one of.
(1) an occurrence of a Uu RLF at the relay node;
(2) reception of an RRC reconfiguration message including a configuration with synchronization at the relay node;
(3) a cell reselection of the relay node;
(4) an occurrence of an RRC connection failure at the relay node;
(5) an RRC connection rejection to the relay node;
(6) an expiry of a timer for RRC setup request (e.g., T300) at the relay node; and
(7) an occurrence of an RRC resume failure at the relay node.

In some embodiments, in case that the relay node functions as the source relay node, the relay node may receive a measurement result from the UE and transmit the measurement result to the network node over the indirect path between the UE and the network node, and may transmit data (e.g., UP data and/or CP data) to the UE over a source link between the UE and the source relay node during the UE performing the path switch procedure. A specific example is described in the embodiments of FIG. 7 as below.

In some embodiments, in case that the relay node functions as the target relay node, the path switch procedure is a DAPS path switch procedure. A specific example is described in the embodiments of FIG. 8 as below.

Some other embodiments of the present disclosure provide an exemplary procedure performed by a UE, for example, UE 110c in FIG. 1 or UE 201A in FIG. 2. Although described with respect to a UE, it should be understood that other devices may be configured to perform a similar procedure.

It should be appreciated by persons skilled in the art that the sequence of the operations in this exemplary procedure of a UE may be changed and some of the operations in this exemplary procedure may be eliminated or modified, without departing from the spirit and scope of the disclosure. Details described in all other embodiments of the present application, e.g., in the embodiments of FIGS. 5-12 are applicable for this exemplary procedure. Moreover, details described in this exemplary procedure are applicable for all the embodiments of FIGS. 1-12.

In particular, in this exemplary procedure, a UE (e.g., UE 201A in FIG. 2) may access a network node (e.g., BS 202 in FIG. 2) over an indirect path via a relay node (e.g., relay UE 201B in FIG. 2). The UE may receive data (e.g., UP data and/or CP data) from the relay node over a link between the UE and the relay node. The UE may receive a notification message (e.g., notification message #1 as described in the embodiments of FIG. 5) and/or a PC5 unicast link release indication (e.g., the PC5 unicast link release indication as described in the embodiments of FIG. 5).

In some embodiments, the notification message is received from the relay node. The PC5 unicast link release indication is indicated by an upper layer of the UE or is received from the relay node.

In some embodiments, in response to reception of the PC5 unicast link release indication, in response to a timer for RRC reestablishment request (e.g., T301) being not running, and in response to the UE in an RRC connected state, the UE may perform a reestablishment procedure.

In some embodiments, in response to reception of the PC5 unicast link release indication, in response to a timer for RRC reestablishment request (e.g., T301) being running, the UE may enter an RRC idle state and/or stop the timer for RRC reestablishment request.

In some embodiments, the UE may perform actions upon entering the RRC idle state, e.g., the actions which may be performed by the UE upon entering the RRC idle state as described in the embodiments of FIG. 5 or in Option Y of operation 1014 in the embodiments of FIG. 11.

In some embodiments, in response to reception of the notification message, the UE may perform a reestablishment procedure, in response to:
(1) a timer for RRC reestablishment request (e.g., T301) being not running and the UE in an RRC connected state; or
(2) the UE being not performing the reestablishment procedure and the UE in the RRC connected state.

In some embodiments, the notification message (e.g., NotificationMessageSidelink message) is associated with one or more conditions at the relay UE. The one or more conditions may include at least one of:
(1) an occurrence of a Uu RLF;
(2) reception of an RRC reconfiguration message including a configuration with synchronization;
(3) a cell reselection;
(4) an occurrence of an RRC connection failure;
(5) an RRC connection rejection;
(6) an expiry of a timer for RRC setup request (e.g., T300); and
(7) an occurrence of an RRC resume failure.

FIG. 7 illustrates a flowchart of exemplary procedure 700 for wireless communications in accordance with some embodiments of the present disclosure. Details described in all of the foregoing embodiments of the present disclosure are applicable for the embodiments shown in FIG. 7. The exemplary procedure 700 may be performed by a remote UE, a relay node (e.g., a relay UE), and a network node (e.g., a BS).

Referring to FIG. 7, in operation 711, remote UE 701 (may also be named as L2 U2N remote UE or the like) may access the serving network node, e.g., BS 703, via an indirect path. The indirect path may be associated with a relay UE (may also be named as L2 U2N relay UE or a source relay UE or the like), e.g., relay UE 702A. In some embodiments, remote UE 701 stays at an RRC connected state. In some embodiments, remote UE 701 may report measurement result(s) based on the configuration(s) from BS 703. The measurement result(s) may include measurement result(s) for a cell or a candidate relay UE, e.g., relay UE 702B.

In operation 712, BS 703 may decide to switch remote UE 701 onto a direct Uu path or another indirect path.

In operation 713, BS 703 may send an RRC reconfiguration message to remote UE 701. In some embodiments, remote UE 701 may stop UP and/or CP transmission(s) via relay UE 702A after reception of the RRC reconfiguration message with the path switch configuration(s) from BS 703.

In operation 714 (which is optional and marked as dotted lines as shown in FIG. 7), remote UE 701 may stop UP and/or CP reception(s) via relay UE 702A after reception of the RRC reconfiguration message with the path switch configuration from(s) BS 703. In some embodiments, remote UE 701 may continue to keep a PC5 link between remote UE 701 and relay UE 702A for data reception.

In operation 715, after remote UE 701 receives the RRC reconfiguration message for path switch, remote UE 701 may start a timer for path switch (e.g., T304 as specified in 3GPP specifications). In some embodiments, if the target node is one cell, remote UE 701 starts the timer for path switch (e.g., T304) and performs a random access (RA) procedure towards the target cell. In some other embodiments, if the target node is one relay UE, in operation 715A (which is optional and marked as dotted lines as shown in FIG. 7), remote UE 701 starts a timer related to the path addition procedure (e.g., T420 as specified in 3GPP specifications) and establishes a PC5 RRC connection towards target relay UE 702B.

In operation 716, remote UE 701 receives a notification message (e.g., NotificationMessageSidelink message) or a PC5 unicast link release indication from source relay UE 702A. For instance, the notification message may be triggered by at least one of:
(1) an occurrence of a Uu RLF at relay UE 702A;
(2) reception of an RRC reconfiguration message including a configuration with synchronization at relay UE 702A;
(3) a cell reselection of relay UE 702A;
(4) an occurrence of an RRC connection failure at relay UE 702A;
(5) an RRC connection rejection to relay UE 702A;
(6) an expiry of a timer for RRC setup request (e.g., T300) at relay UE 702A; and
(7) an occurrence of an RRC resume failure at relay UE 702A.

In some embodiments, the notification message (e.g., NotificationMessageSidelink message) may include a type indication (e.g., “indicationType”), which may indicate that the notification message is due to one of a relay Uu RLF, relay handover, relay cell reselection, and/or relay connection failure.

In operation 717 (which is optional and marked as dotted lines as shown in FIG. 7), there may be following three options in different embodiments, i.e., Option 1, Option 2, and Option 3.
(1) Option 1: in some embodiments, remote UE 701 may ignore the notification message or the PC5 unicast link release indication from source relay UE 702A when the timer for path switch (e.g., T304) is running.
(2) Option 2: in some further embodiments, remote UE 701 may stop receiving CP and/or UP data upon the reception of the notification message or the PC5 unicast link release indication from source relay UE 702A when the timer for path switch (e.g., T304) is running.
(3) Option 3: in some other embodiments, remote UE 701 may release the PC5 RRC connection upon the reception of the notification message or the PC5 unicast link release indication from source relay UE 702A when the timer for path switch (e.g., T304) is running.

In operation 718, remote UE 701 may stop the timer for path switch (e.g., T304) upon successfully completing the RA procedure to BS 703 or upon sending the RRC reconfiguration complete message to BS 703.

In operation 719, BS 703 may send an RRC reconfiguration message to relay UE 702A to reconfigure the connection between relay UE 702A and BS 703. The RRC reconfiguration message to relay UE 702A can be sent any time after operation 713 based on BS 703's implementation (e.g., to release Uu and PC5 relay RLC channel configuration for relaying, and bearer mapping configuration related to remote UE 701). For instance, in some embodiments, operation 719 in which the RRC reconfiguration message is sent is after operation 713 before operation 718.

In operation 720, either relay UE 702A or remote UE 701 may release the PC5-RRC connection between remote UE 701 and relay UE 702A and may indicate the upper layer of remote UE 701 to release the PC5-RRC connection (i.e., the PC5 unicast link). Then, the data path between remote UE 701 and BS 703 is switched from the indirect path to the target relay node, e.g., relay UE 702B.

FIG. 8 illustrates a flowchart of exemplary procedure 800 for wireless communications in accordance with some embodiments of the present disclosure. Details described in all of the foregoing embodiments of the present disclosure are applicable for the embodiments shown in FIG. 8. The exemplary procedure 800 may be performed by a remote UE, a relay node (e.g., a relay UE), and a network node (e.g., a BS).

Referring to FIG. 8, in operation 811, remote UE 801 (may also be named as L2 U2N remote UE or the like) accesses the serving network node, e.g., BS 804, via an indirect path. The indirect path is associated with a relay UE (may also be named as L2 U2N relay UE or a source relay UE or the like), e.g., source relay UE 802. In some embodiments, remote UE 801 stays at an RRC connected state. In some embodiments, remote UE 801 reports measurement result(s) based on the configuration(s) from BS 804. The measurement result(s) may include measurement result(s) for a cell or a candidate relay UE, e.g., target relay UE 803.

In operation 812, BS 804 decides to switch remote UE 801 onto a direct Uu path or another indirect path.

In operation 813, BS 804 sends an RRC reconfiguration message for path switch, e.g., including configuration(s) associated with a DAPS procedure, to remote UE 801. In some embodiments, remote UE 801 may continue to keep the source PC5 link between remote UE 801 and source relay UE 802 for data reception or data transmission.

In operation 814, after remote UE 801 receives the RRC reconfiguration message for path switch, remote UE 801 may start a timer for path switch (e.g., T304).

In operation 815, in case that the target node is one relay UE, e.g., target relay UE 803, remote UE 801 starts a timer related to the path addition procedure (e.g., T420) and establishes a PC5 RRC connection towards target relay UE 803.

In operation 816, in some embodiments, remote UE 801 may receive a notification message (e.g., NotificationMessageSidelink message) or a PC5 unicast link release indication from target relay UE 803; or, in some other embodiments, remote UE 801 may detect an RLF on the target PC5 link between remote UE 801 and target relay UE 803. For instance, the notification message may be triggered by at least one of:
(1) an occurrence of a Uu RLF at target relay UE 803;
(2) reception of an RRC reconfiguration message including a configuration with synchronization at target relay UE 803;
(3) a cell reselection of target relay UE 803;
(4) an occurrence of an RRC connection failure at target relay UE 803; (5) an RRC connection rejection to target relay UE 803;
(6) an expiry of a timer for RRC setup request (e.g., T300) at target relay UE 803; and
(7) an occurrence of an RRC resume failure at target relay UE 803.

In some embodiments, the notification message (e.g., NotificationMessageSidelink message) may include a type indication (e.g., “indicationType”), which may indicate that the notification message is due to one of a relay Uu RLF, relay handover, relay cell reselection, and/or relay connection failure.

After operation 816, there may be following three options in different embodiments, i.e., Option A (operations 817A and 818A are performed), Option B (operations 817B, 818B, and 819B are performed), and Option C (operations 817A, 818B, and 819B are performed).

Option A: In operation 817A, if the source link between remote UE 801 and source relay UE 802 is still available, remote UE 801 may revert (fallback) to the source link. In operation 818A, remote UE 801 may initiate a failure information procedure to report failure related information associated with the DAPS path switch procedure. For instance, the failure related information may include at least one of: the reception of the notification message, or the reception of the PC5 unicast link release indication, or detection of an RLF on a PC5 link between remote UE 801 and target relay UE 803.

Option B: In operation 817B, if the source link is not available, remote UE 801 performs a reestablishment procedure to BS 804. In operation 818B, after successfully completing the reestablishment procedure, remote UE 801 may receive a request (e.g., a UE information request message) from BS 804. In operation 819B, remote UE 801 may transmit a response (e.g., a UE information response message) including failure related information to BS 804, for a self-optimisation (SON) purpose. For instance, the failure related information may include at least one of: the reception of the notification message, or the reception of the PC5 unicast link release indication, or detection of an RLF on a PC5 link between remote UE 801 and target relay UE 803.

Option C: In operation 817A, if the source link between remote UE 801 and source relay UE 802 is still available, remote UE 801 may revert (fallback) to the source link. In operation 818B, after reverting to the source link, remote UE 801 may receive a request (e.g., a UE information request message) from BS 804. In operation 819B, remote UE 801 may transmit a response (e.g., a UE information response message) including failure related information to BS 804, for a self-optimisation (SON) purpose. For instance, the failure related information may include at least one of: the reception of the notification message, or the reception of the PC5 unicast link release indication, or detection of an RLF on a PC5 link between remote UE 801 and target relay UE 803.

FIG. 9 illustrates a flowchart of exemplary procedure 900 for wireless communications in accordance with some embodiments of the present disclosure. Details described in all of the foregoing embodiments of the present disclosure are applicable for the embodiments shown in FIG. 9. The exemplary procedure 900 may be performed by a remote UE, a relay node (e.g., a relay UE), and a network node (e.g., a BS).

Referring to FIG. 9, in operation 911, remote UE 901 (may also be named as L2 U2N remote UE or the like) accesses the serving network node, e.g., BS 903, via an indirect path. The indirect path is associated with a relay UE (may also be named as L2 U2N relay UE or the like), e.g., relay UE 902. In some embodiments, if remote UE 901 stays at an RRC connected state, remote UE 901 reports measurement result(s) based on the configuration(s) from BS 903. The measurement result(s) may include measurement result(s) for a cell or a candidate relay UE.

In operation 912, relay UE 902 transmits a PC5 unicast link release indication to the connected remote UE 901. In some embodiments, relay UE 902 may transmit the PC5 unicast link release indication to the remote UE 901 when relay UE 902 declares an RLF on a Uu link. In some other embodiments, relay UE 902 may transmit the PC5 unicast link release indication to remote UE 901 when relay UE 902 receives an RRC reconfiguration message including a configuration with synchronization from BS 903.

In some embodiments, in operation 912A (which is optional and marked as dotted lines as shown in FIG. 9), after the upper layer(s) of remote UE 901 receives the PC5 unicast link release indication from relay UE 902, the upper layer will indicate the PC5 unicast link release indication to an AS layer of remote UE 901. Upon the PC5 unicast link release indication indicated by the upper layer(s) at remote UE 901, remote UE 901 shall initiate a reestablishment procedure to BS 903 if a timer for RRC reestablishment request (e.g., T301) is not running.

In operation 913, after remote UE 901 receives the PC5 unicast link release indication from the relay UE, remote UE 901 performs a reestablishment procedure to BS 903.

FIG. 10 illustrates a flowchart of exemplary procedure 1000 for wireless communications in accordance with some embodiments of the present disclosure. Details described in all of the foregoing embodiments of the present disclosure are applicable for the embodiments shown in FIG. 10. The exemplary procedure 1000 may be performed by a remote UE, a relay node (e.g., a relay UE), and a network node (e.g., a BS).

Referring to FIG. 10, in operation 1011, remote UE 1001 (may also be named as L2 U2N remote UE or the like) accesses the serving network node, e.g., BS 1003, via an indirect path. The indirect path is associated with a relay UE (may also be named as L2 U2N relay UE or the like), e.g., relay UE 1002. In some embodiments, if remote UE 1001 stays at an RRC connected state, remote UE 1001 reports measurement result(s) based on the configuration(s) from BS 1003. The measurement result(s) may include measurement result(s) for a cell or a candidate relay UE.

In operation 1012, remote UE 1001 transmits a reestablishment request and starts a timer for RRC reestablishment request (e.g., T301) upon transmitting the reestablishment request.

In operation 1013, relay UE 1002 transmits a PC5 unicast link release indication to the connected remote UE 1001. In some embodiments, relay UE 1002 may transmit the PC5 unicast link release indication to remote UE 1001 when relay UE declares 1002 an RLF on a Uu link. In some embodiments, relay UE 1002 may transmit the PC5 unicast link release indication to remote UE 1001 when relay UE 1002 receives an RRC reconfiguration message including a configuration with synchronization from BS 1003. In some embodiments, remote UE 1001 receives the PC5 unicast link release indication from relay UE 1002 when remote UE 1001 performs a reestablishment procedure.

In operation 1014, there may be following two options in different embodiments, i.e., Option X and Option Y.

Option X: in some embodiments, upon the PC5 unicast link release indication indicated by the upper layer(s) at remote UE 1001 and if remote UE 1001 is in an RRC connected state while a timer for RRC reestablishment request (e.g., T301) is running, remote UE 1001 may enter an RRC idle state and/or remote UE 1001 may stop the timer for RRC reestablishment request (e.g., T301).

Option Y: in some embodiments, upon the PC5 unicast link release indication indicated by the upper layer(s) at remote UE 1001 and if remote UE 1001 is in an RRC connected state while the timer for RRC reestablishment request (e.g., T301) is running, remote UE 1001 performs actions upon going to an RRC idle state. For instance, upon going to the RRC idle state, the UE may reset MAC; stop all timers that are running except timers T302, T320, T325, T330, T331 and T400; discard the UE Inactive AS context, if any; release the suspendConfig, if configured; remove all the entries within VarConditionalReconfig, if any; discard the K_{gNB} key, the S-K_{gNB} key, the S-K_{eNB} key, the K_{RRCenc} key, the K_{RRCint} key, the K_{UPint} key and the K_{UPenc} key, if any; release all radio resources, including release of the RLC entity, the BAP entity, the MAC configuration and the associated PDCP entity and SDAP for all established RBs; indicate the release of the RRC connection to upper layers together with the release cause; discard any segments of segmented RRC messages stored; and/or enter the RRC idle state and perform a cell selection.

FIG. 11 illustrates a flowchart of exemplary procedure 1100 for wireless communications in accordance with some embodiments of the present disclosure. Details described in all of the foregoing embodiments of the present disclosure are applicable for the embodiments shown in FIG. 11. The exemplary procedure 1100 may be performed by a remote UE, a relay node (e.g., a relay UE), and a network node (e.g., a BS).

Referring to FIG. 11, in operation 1111, remote UE 1101 (may also be named as L2 U2N remote UE or the like) accesses the serving network node, e.g., BS 1103, via an indirect path. The indirect path is associated with a relay UE (may also be named as L2 U2N relay UE or the like), e.g., relay UE 1102. In some embodiments, if remote UE 1101 stays at an RRC connected state, remote UE 1101 reports measurement result(s) based on the configuration(s) from BS 1103. The measurement result(s) may include measurement result(s) for a cell or a candidate relay UE.

In operation 1112, relay UE 1102 may transmit a notification message (e.g., NotificationMessageSidelink message) due to a Uu RLF or reception of an RRC reconfiguration message including a configuration with synchronization to remote UE 1101. For instance, the notification message may be triggered by at least one of:
(1) an occurrence of a Uu RLF at relay UE 1102;
(2) reception of an RRC reconfiguration message including a configuration with synchronization at relay UE 1102;
(3) a cell reselection of relay UE 1102;
(4) an occurrence of an RRC connection failure at relay UE 1102;
(5) an RRC connection rejection to relay UE 1102;
(6) an expiry of a timer for RRC setup request (e.g., T300) at relay UE 1102; and
(7) an occurrence of an RRC resume failure at relay UE 1102.

In some embodiments, relay UE 1102 transmits the notification message due to a Uu RLF when relay UE 1102 declares an RLF on the Uu link.

In some embodiments, relay UE 1102 transmits the notification message when relay UE 1102 receives the RRC reconfiguration message including the configuration with synchronization.

In some embodiments, the notification message (e.g., NotificationMessageSidelink message) may include a type indication (e.g., “indicationType”), which may indicate that the notification message is due to one of a relay Uu RLF, relay handover, relay cell reselection, and/or relay connection failure.

In operation 1113, there may be following two options in different embodiments, i.e., Option I and Option II.

Option I: in some embodiments, after remote UE 1101 receives the notification message from relay UE 1102, if remote UE 1101 is in the RRC connected state and if a timer for RRC reestablishment request (e.g., T301) is not running, remote UE 1101 shall initiate a reestablishment procedure to BS 1103.

Option II: in some embodiments, after remote UE 1101 receives the notification message from the relay UE, if remote UE 1101 is in the RRC connected state and if remote UE 1101 is not performing a reestablishment procedure, remote UE 1101 shall initiate a reestablishment procedure to BS 1103.

Details described in all other embodiments of the present application (for example, details regarding how to handle a connection in a L2 U2N relay case) are applicable for the embodiments of any of FIGS. 7-11. Moreover, details described in the embodiments of any of FIGS. 7-11 are applicable for all embodiments of FIGS. 1-6 and 12. It should be appreciated by persons skilled in the art that the sequence of the operations in exemplary procedure in the embodiments of any of FIGS. 7-11 may be changed and some of the operations in exemplary procedure in the embodiments of any of FIGS. 7-11 may be eliminated or modified, without departing from the spirit and scope of the disclosure.

FIG. 12 illustrates a block diagram of exemplary apparatus 1200 according to some embodiments of the present disclosure.

As shown in FIG. 12, the apparatus 1200 may include at least one processor 1206 and at least one transceiver 1202 coupled to the processor 1206. The apparatus 1200 may be a UE, a relay node (e.g., a relay UE), or a network node (e.g., a BS).

Although in this figure, elements such as the at least one transceiver 1202 and processor 1206 are described in the singular, the plural is contemplated unless a limitation to the singular is explicitly stated. In some embodiments of the present application, the transceiver 1202 may be divided into two devices, such as a receiving circuitry and a transmitting circuitry. In some embodiments of the present application, the apparatus 1200 may further include an input device, a memory, and/or other components.

In some embodiments of the present application, the apparatus 1200 may be a UE. The transceiver 1202 and the processor 1206 may interact with each other so as to perform the operations with respect to the UEs described in FIGS. 1-11. In some embodiments of the present application, the apparatus 1200 may be a relay node (e.g., a relay UE). The transceiver 1202 and the processor 1206 may interact with each other so as to perform the operations with respect to the relay nodes described in FIGS. 1-11. In some embodiments of the present application, the apparatus 1200 may be a network node (e.g., a BS). The transceiver 1202 and the processor 1206 may interact with each other so as to perform the operations with respect to the network node described in FIGS. 1-11.

In some embodiments of the present application, the apparatus 1200 may further include at least one non-transitory computer-readable medium. For example, in some embodiments of the present disclosure, the non-transitory computer-readable medium may have stored thereon computer-executable instructions to cause the processor 1206 to implement the method with respect to the UEs as described above. For example, the computer-executable instructions, when executed, cause the processor 1206 interacting with transceiver 1202 to perform the operations with respect to the UEs described in FIGS. 1-11.

In some embodiments of the present disclosure, the non-transitory computer-readable medium may have stored thereon computer-executable instructions to cause the processor 1206 to implement the method with respect to the relay nodes (e.g., the relay UEs) as described above. For example, the computer-executable instructions, when executed, cause the processor 1206 interacting with transceiver 1202 to perform the operations with respect to the relay nodes described in FIGS. 1-11.

In some embodiments of the present disclosure, the non-transitory computer-readable medium may have stored thereon computer-executable instructions to cause the processor 1206 to implement the method with respect to the network nodes (e.g., the BSs) as described above. For example, the computer-executable instructions, when executed, cause the processor 1206 interacting with transceiver 1202 to perform the operations with respect to the network nodes described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
access a network node over a first indirect path associated with a source relay node;
in response to reception of a radio resource control (RRC) reconfiguration message for path switch via the transceiver from the network node, perform a path switch procedure from the first indirect path to a target path, wherein the target path is a direct path between the UE and the network node or is a second indirect path between the UE and the network node associated with a target relay node; and
receive data via the transceiver from the source relay node over a source link between the UE and the source relay node during the path switch procedure.

2. The UE of claim 1, wherein the at least one processor is configured to cause the UE to, in response to the reception of the RRC reconfiguration message for path switch, stop reception of at least one of user plane (UP) data or control plane (CP) data via the transceiver from the source relay node.

3. The UE of claim 1, wherein the at least one processor is configured to cause the UE to:
receive a first notification message or a PC5 unicast link release indication from the source relay node during the path switch procedure;
in response to reception of the first notification message or the PC5 unicast link release indication and in response to a timer for path switch being running, perform at least one of:
ignoring the first notification message or the PC5 unicast link release indication;
stopping reception of at least one of UP data or CP data from the source relay node;
or
releasing the source link between the UE and the source relay node.

4. The UE of claim 3, wherein the at least one processor is configured to cause the UE to receive the first notification message from the source relay node, and wherein the PC5 unicast link release indication is indicated by an upper layer of the UE or is received via the transceiver from the source relay node.

5. The UE of claim 1, wherein, in response to the path switch procedure being a dual active protocol stack (DAPS) path switch procedure, the at least one processor is configured to cause the UE to perform at least one of:
receiving a second notification message via the transceiver from the target relay node;
receiving a PC5 unicast link release indication, wherein the PC5 unicast link release indication is indicated by an upper layer of the UE or is received via the transceiver from the target relay node; or
detecting a radio link failure (RLF) on a link between the UE and the target relay node.

6. The UE of claim 5, wherein the at least one processor is configured to cause the UE to perform at least one of:
reverting to the source link in response to the source link being available; or
transmitting failure related information via the transceiver to the network node.

7. The UE of claim 5, wherein the at least one processor is configured to cause the UE to:
perform a reestablishment procedure in response to the source link being not available;
after completing the reestablishment procedure, receive a request via the transceiver from the network node; and
transmit a response including failure related information via the transceiver to the network node.

8. The UE of claim 6, wherein the failure related information indicates at least one of:
reception of the second notification message from the target relay node;
reception of the PC5 unicast link release indication; or
detection of the RLF on the link between the UE and the target relay node.

9. The UE of claim 1, wherein the at least one processor is configured to cause the UE to:
receive a PC5 unicast link release indication before the reception of the RRC reconfiguration message for path switch; and
in response to a timer for RRC reestablishment request being not running and in response to the UE in an RRC connected state, perform a reestablishment procedure.

10. The UE of claim 1, wherein the at least one processor is configured to cause the UE to:
receive a PC5 unicast link release indication before the reception of the RRC reconfiguration message for path switch; and
in response to a timer for RRC reestablishment request being running, perform at least one of:
entering an RRC idle state; or
stopping the timer for RRC reestablishment request.

11. The UE of claim 10, wherein, in response to the timer for RRC reestablishment request being running, the at least one processor is configured to cause the UE to perform actions upon entering the RRC idle state.

12. The UE of claim 9, wherein the PC5 unicast link release indication is indicated by an upper layer of the UE or is received via the transceiver from the source relay node.

13. A user equipment (UE), comprising:
at least one memory; and
at least one processor coupled with the at least one memory and configured to cause the UE to:
receive a notification message from a source relay node and
perform a reestablishment procedure, in response to:
a timer for a radio resource control (RRC) reestablishment request being not running and the UE in an RRC connected state; or
the UE being not performing the reestablishment procedure and the UE in the RRC connected state.

14. The UE of claim 3, wherein at least one of the first notification message, the second notification message, or the third notification message is triggered by at least one of:
an occurrence of a Uu RLF;
reception of an RRC reconfiguration message including a configuration with synchronization;
a cell reselection;
an occurrence of an RRC connection failure;
an RRC connection rejection;
an expiry of a timer for RRC setup request; and
an occurrence of an RRC resume failure.

15. A relay node, comprising:
at least one memory; and
at least one processor coupled with the at least one memory and configured to cause the relay node to:
transmit at least one of a notification message or a PC5 unicast link release indication via the transceiver to a user equipment (UE) during the UE performing a path switch procedure from a source path to a target path,
wherein the source path is a first direct path between the UE and the network node or is a first indirect path between the UE and the network node associated with a source relay node;
wherein the target path is a second direct path between the UE and the network node or is a second indirect path between the UE and the network node associated with a target relay node; and
wherein the relay node functions as the source relay node or the target relay node.

16. A processor for wireless communication, comprising:
at least one controller coupled with at least one memory and configured to cause the processor to:
access a network node over a first indirect path associated with a source relay node;
in response to reception of a radio resource control (RRC) reconfiguration message for path switch via the transceiver from the network node, perform a path switch procedure from the first indirect path to a target path, wherein the target path is a direct path between the UE and the network node or is a second indirect path between the UE and the network node associated with a target relay node; and
receive data via the transceiver from the source relay node over a source link between the UE and the source relay node during the path switch procedure.

17. The processor of claim 16, wherein the at least one controller is configured to cause the UE to, in response to the reception of the RRC reconfiguration message for path switch, stop reception of at least one of user plane (UP) data or control plane (CP) data via the transceiver from the source relay node.

18. The processor of claim 16, wherein the at least one controller is configured to cause the UE to:
receive a first notification message or a PC5 unicast link release indication from the source relay node during the path switch procedure;
in response to reception of the first notification message or the PC5 unicast link release indication and in response to a timer for path switch being running, perform at least one of:
ignoring the first notification message or the PC5 unicast link release indication;
stopping reception of at least one of UP data or CP data from the source relay node;
or
releasing the source link between the UE and the source relay node.

19. The processor of claim 18, wherein the at least one controller is configured to cause the processor to receive the first notification message from the source relay node, and wherein the PC5 unicast link release indication is indicated by an upper layer of the UE or is received via the transceiver from the source relay node.

20. The processor of claim 16, wherein, in response to the path switch procedure being a dual active protocol stack (DAPS) path switch procedure, the at least one controller is configured to cause the processor to perform at least one of:
receiving a second notification message via the transceiver from the target relay node;
receiving a PC5 unicast link release indication, wherein the PC5 unicast link release indication is indicated by an upper layer of the UE or is received via the transceiver from the target relay node; or
detecting a radio link failure (RLF) on a link between the UE and the target relay node.
